(19) United States
(12) Patent Application Publication
(10) Pub. No.: US 2008/0212064 A1
(43) Pub. Date: Sep. 4, 2008

(54) Hand-Held Measuring Device With Measured Value Memory and Microphone For Entering Spoken Messages Related Art

(76) Inventors: Uwe Skultety-Betz, Leinfelden-Echterdingen (DE); Bjoern Haase, Stuttgart (DE); Joerg Stierle, Waldenbuch (DE); Peter Wolf, Leinfelden-Echterdingen (DE); Kai Renz, Leinfelden-Echterdingen (DE); Clemens Schulte, Stuttgart (DE)

Correspondence Address: MICHAEL J. STRIKER, 103 EAST NECK ROAD, HUNTINGTON, NY, 11743, US

(21) Appl. No.: 11/909,247

(22) PCT Filed: Apr. 25, 2006
(86) PCT No.: PCT/EP2006/061803

§ 371 Date: Sep. 20, 2007

(30) Foreign Application Priority Data
Jun. 17, 2005 (DE) 102005028134.6

(51) Int. Cl. G01C 3/00; G10L 15/26

(52) U.S. Cl. 356/3; 704/235; 704/E15.043

(57) ABSTRACT

The invention relates to a hand-held measuring device, in particular, a laser distance measuring device (10), comprising a memory unit (12) for the storage of at least one electronically recorded measured value (14). According to the invention, the hand-held measuring device comprises a microphone unit (16) suitable for the recording of at least one voice note (18).

### RELATED ART

The present invention is directed to a hand-held measuring device according to the preamble of claim 1.

Laser distance measuring devices are known that include memory units for storing electronically detected measured values. The measured values are depicted on a display unit and may be stored by an operator in the memory unit. They may then be read out of the memory unit in sequential order.

Furthermore, an analog tape measure with a microphone unit and a memory unit is known, under the trade name “Zircon Repeater 25”, that an operator may use to store measured values detected using the tape measure by speaking the measured values into the device.

### ADVANTAGES OF THE INVENTION

The present invention is directed to a hand-held measuring device, in particular a laser distance measuring device, with a memory unit for storing at least one electronically detected measured value.

It is provided that the hand-held measuring device includes a microphone unit for entering at least one spoken message. In a simple manner, a spoken message may therefore be entered while a measurement is being carried out. The complicated procedure of writing down the message may be advantageously eliminated. The operator may record important circumstances that accompany a measurement, e.g., a start or end point of a distance measurement, simply by making a voice recording, without his having to let go of the hand-held measuring device. In addition, the location and time of the measurement, a measurement direction, information about a suspected measurement accuracy or the like may be stored in the spoken message. It is also feasible, however, that control commands may also be issued via the microphone unit, in combination with a voice recognition module.

A spoken message may be any comment related to a measurement procedure that appears reasonable to one skilled in the art. The microphone unit may be designed as a microphone integrated in the hand-held measuring device, or as an interface for connecting an external microphone. A “hand-held measuring device” refers to any measuring device used in a tool application and/or handyman application, and, in fact, any distance measuring device in particular. The inventive means of attaining the object of the present invention may also be used in combination with other measuring devices, however, e.g., angle measuring devices, balances, current and/or voltage measuring devices, or the like. Hand-held measuring devices are particularly more robust and dust-proof than other types of measuring devices.

In a refinement of the present invention, it is provided that the memory unit is provided for storing a spoken message. A separate storage medium may be advantageously eliminated. The memory unit may be designed particularly simply as a rewritable electronic memory unit.

When the hand-held measuring device includes an assigning means for assigning the is spoken messages to a measured value, a large number of measured values and spoken messages may be stored in the memory unit in a transparent manner. The assigning means may be designed, e.g., as a common data structure that includes the measured value and the spoken message, or as pointer variables assigned to the measured value and/or the spoken message. In further embodiments of the present invention, the assigning means could be designed as a data base program.

When the hand-held measuring device includes a speaker unit for playing back the spoken message, the spoken message may be played back easily without the need to connect the hand-held measuring device to a separate speaker unit. To prevent damage and contamination, the speaker unit is advantageously integrated in the housing of the distance measuring device.

An advantageous evaluation of the measured values, e.g., on a stationary computer, may be attained when the hand-held measuring device includes an interface for reading out the measured value and the spoken message. The interface may also be basically provided, e.g., as a W-LAN interface, as a Bluetooth interface, or as a GSM modem for wireless communication with the stationary computer.

When the hand-held measuring device includes a compressing function for compressing a data record of the spoken message, a particularly large number of spoken messages may be stored in a limited memory unit. Advantageous compressing functions are, e.g., functions that convert the spoken message into an MPEG format or the like.

In a refinement of the present invention, it is provided that the hand-held measuring device includes a voice recognition function for translating the spoken message into characters. This results in good compression while also ensuring that a file assigned to the spoken message is easily transferable.

It would also be feasible for the hand-held measuring device to include a camera in addition to the microphone unit, which the operator may advantageously use to document circumstances that accompany the measurement, in the form of images.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a laser distance measuring device with a microphone unit and a speaker unit,

FIG. 2 shows a flow chart for assigning a spoken message to a measured value,

FIG. 3 shows a flow chart for assigning a spoken message to a measured value, in an alternative embodiment of the present invention, and

FIG. 4 shows a laser distance measuring device, in an alternative embodiment of the present invention.

### DESCRIPTION OF THE EXEMPLARY EMBODIMENTS

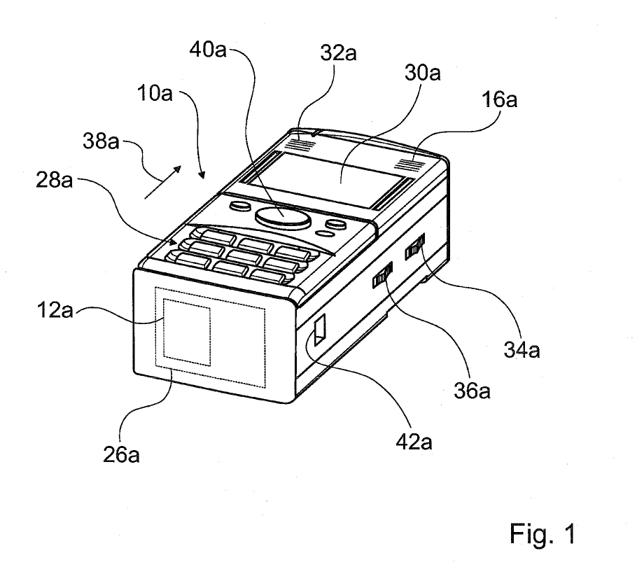

FIG. 1 shows a laser distance measuring device 10 with an integrated arithmetic and control unit 26a, which includes a memory unit 12a. Control unit 26a receives control signals from a keypad 28a, which is located on a top side of a housing of laser distance measuring device 10a in front—relative to a measuring direction 38a—of a display 30a, relative to a measuring direction 38a. Display 30 is controllable using arithmetic and control unit 26a.

A microphone unit 16a is located behind display 30a-relative to measuring direction 38a—which is connected with an audio input of arithmetic and control unit 26a. A speaker unit 32a is controllable via an audio output of arithmetic and control unit 26a, which is also integrated in the housing of laser distance measuring device 10a.

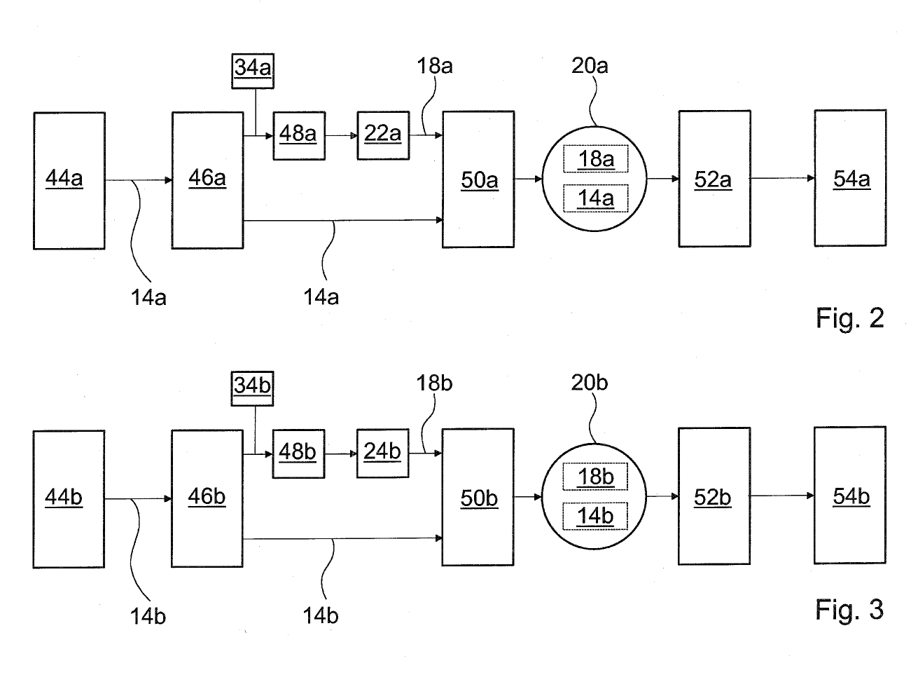

Microphone unit 16a and speaker unit 32a are used to input and output, respectively, spoken messages 18a, which may be stored in memory unit 12a (FIG. 2). A recording switch 34a and a playback switch 36a for activating a recording mode 48 or a playback mode, respectively, of laser distance measuring device 10a are located on the side of the housing of laser distance measuring device 10a.

An interface 42a for connecting a not-shown data cable is also located on the housing. In the exemplary embodiment shown, interface 42a is designed as a plug-and-play-capable USB interface per IEEE standard 1394, although other formats of interface 42a are also feasible. Via interface 42a, an external computer may read data records—measured values 14a and spoken messages 18a assigned to measured values 14a in particular—out of memory unit 12a and, optionally, download them.

On a side facing measuring direction 38a, laser distance measuring device 10a includes a system—known per se—of laser diodes and photocells, which enables detection of a distance of the object via a transit time measurement of a portion of a laser beam that was emitted in measuring direction 38a, modulated, and reflected on an object. To this end, the reflected portion of the modulated laser beam is superposed on and/or applied to the photocell with a non-reflected portion of the laser beam for interference.

Using keypad 28a, various measurement programs may be activated, and various data records stored in memory unit 12a may be called up. A measurement button 40a is used to start a distance measurement. Additional elements of keypad 28a include cursor buttons, buttons for selecting a program, and a memory button.

FIG. 2 shows a sequence of steps that is started in a length-measuring mode when measurement button 40a is pressed. In a measuring step 44a, arithmetic and control unit 26a determines the distance based on the transit time of the modulated laser beam, the distance being represented by a measured value 14a.

In a voice input step 46a, measured value 14a appears in a display 30a together with a symbol that prompts an operator to input a spoken message 18a. When the operator now actuates recording switch 34a, arithmetic and control unit 26a records spoken message 18a in a recording mode 48a, compresses it in a compressing function 22a, and assigns measured value 14a and compressed spoken message 18a—in an assigning step 50a—to a common data structure, which is an assigning means 20a for establishing an assignment between measured value 14a and spoken message 18a.

In a subsequent query step 52a, the operator is asked via display 30a whether the data structure formed by assigning means 20a should be stored in memory unit 12a. If the operator actuates a memory button of keypad 28a, arithmetic and control unit 26a stores—in a storing step 54a—measured value 14a and spoken message 18a together with assigning means 20a in memory unit 12a. If the operator actuates a cancel button instead, assigning means 20a-together with measured value 14a and spoken message 18a—are deleted.

To call up stored spoken message 18a and measured value 14a, the operator may actuate a recall button on keypad 28a and, using the cursor keys, select the corresponding assigning means 20a from a list of assigning means. When measured value 14a appears in digits, or when an ordinal number assigned to selected assigning means 20a appears in display 30a, the operator may actuate playback switch 36a to replay spoken message 18a. Spoken message 18a is then played back over speaker unit 32a by arithmetic and control unit 26a.

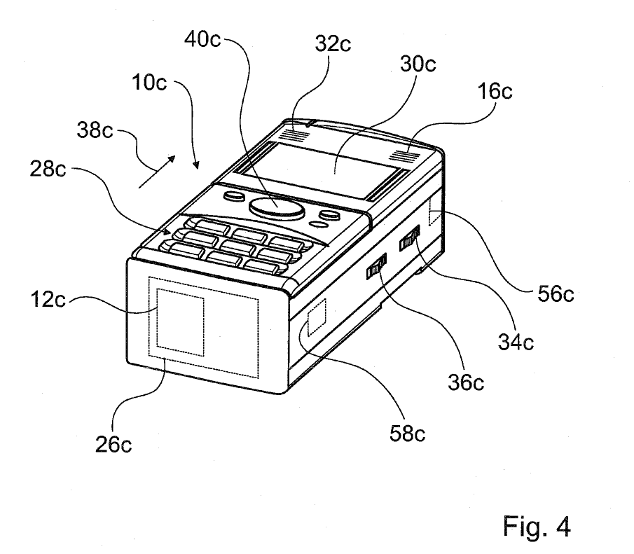

FIGS. 3 and 4 show alternative embodiments of the present invention. The description will mainly address the differences from the exemplary embodiment shown in FIGS. 1 and 2. With regard for features that are identical, reference is made to the description of FIGS. 1 and 2. Similar features are provided with the same reference numerals, appended with the letters a-c to distinguish between the exemplary embodiments.

FIG. 3 shows an alternative flow chart for assigning a measured value 14b to a spoken message 18b. Instead of a compressing function, spoken message 18b is subjected to a voice recognition function 24b, in which spoken message 18b is translated into characters. The characters are then stored in memory unit 12b in the ASCII format or in another file format that appears reasonable to one skilled in the art. To play back spoken message 18b, it may be depicted on a display and/or read out by a voice synthesizer.

In an embodiment with an alternative design (FIG. 4) of an inventive laser distance measuring device 10c, it includes wireless communication means 58c, e.g., in the form of a W-LAN or an infrared interface, via which laser distance measuring device 10c may communicate with a central computer for evaluating the measured data. A voice recognition function may be installed on the central computer in this embodiment of the present invention.

Laser distance measuring device 10c also includes an integrated digital camera 56c. A data structure that assigns a measured value to a spoken message and vice versa also includes a memory location for storing an image that was recorded by digital camera 56c and may be depicted on display 30c.

What is claimed is:

1. A hand-held measuring device, in particular a laser distance measuring device (10), with a memory unit (12) for storing at least one electronically detected measured value (14), characterized by a microphone unit (16) that is provided for inputting at least one spoken message (18).

2. The hand-held measuring device as recited in claim 1, wherein
the memory unit (12) is provided for storing the spoken message (18).

3. The hand-held measuring device as recited in claim 1, characterized by an assigning means (20) for assigning the spoken message (18) to the measured value (14).

4. The hand-held measuring device as recited in claim 1, characterized by a speaker unit (32) for playing back the spoken message (18).

5. The hand-held measuring device as recited in claim 1, characterized by an interface (42) for reading out the measured value and the spoken message (18).

6. The hand-held measuring device as recited in claim 1, characterized by a compressing function (22) for compressing a data record of the spoken message (18).

7. The hand-held measuring device as recited in claim 1, characterized by a voice recognition function (24) for translating the spoken message (18) into characters.

8. The hand-held measuring device as recited in claim 1, characterized by a digital camera (56) for documenting circumstances that accompany a measurement.
